(19) United States
(12) Patent Application Publication
(10) Pub. No.: US 2014/0055530 A1
(43) Pub. Date: Feb. 27, 2014

(54) LIQUID EJECTING HEAD AND LIQUID EJECTING APPARATUS

(71) Applicant: Seiko Epson Corporation, Tokyo (JP)

(72) Inventors: Shinichi Itaya, Matsumoto (JP); Kinya Ozawa, Shiojiri (JP)

(73) Assignee: Seiko Epson Corporation, Tokyo (JP)

(21) Appl. No.: 13/955,528

(22) Filed: Jul. 31, 2013

(30) Foreign Application Priority Data
Aug. 23, 2012 (JP) 2012-184258

(51) Int. Cl. B41J 2/14

(52) U.S. Cl. CPC B41J 2/14201
USPC 347/68

(57) ABSTRACT

A liquid ejecting head includes a pressure generation chamber to which ink containing a flat plate-like particle is filled, a piezoelectric element generating pressure change on the ink in the pressure generation chamber, and a nozzle plate having a nozzle for discharging the ink from the pressure generation chamber due to the pressure change. The nozzle includes a first nozzle portion at an ink discharge surface side, and a second nozzle portion communicating with the first nozzle portion and formed at the pressure generation chamber side. When an opening diameter of the first nozzle portion at the discharge surface side is φ1 and an opening diameter of the second nozzle portion at the pressure generation chamber side is φ2, the nozzle satisfies φ2/φ1≧1.4.

### BACKGROUND

1. Technical Field

The present invention relates to a liquid ejecting head and a liquid ejecting apparatus, and in particular, relates to a liquid ejecting head and a liquid ejecting apparatus that are used effectively when ink containing flat plate-like particles is discharged.

2. Related Art

As a representative example of liquid ejecting heads that are mounted on liquid ejecting apparatuses and discharge liquid through nozzles, known are ink jet recording heads that discharge ink droplets through the nozzles by using pressures generated by displacement of piezoelectric actuators, for example. The ink jet recording heads of this type have the following configuration generally. That is, the piezoelectric actuators are provided at one surface side of a flow path formation substrate on which pressure generation chambers communicating with the nozzles are formed, and the piezoelectric actuators are deformed to pressurize ink in the pressure generation chambers. With this, ink droplets are discharged through the nozzle.

Among such ink jet recording heads, there is an ink jet recording head that discharges metallic ink containing a metal pigment of flat plate-like particles in order to produce a printed matter having metal glossiness (for example, see JP-A-2007-46034).

In the ink jet recording head that discharges the metallic ink, when flow with the discharge is generated on a flow path in the head, even if viscosity of the metallic ink is equivalent to that of normal ink, a large number of flat plate-like particles as the metal pigment contained in the metallic ink disturb the flow in the flow path on a region in the vicinity of a wall surface of the flow path. Due to this, a thick boundary layer is formed. It is considered that the thick boundary layer is formed for the following manner. That is, the velocity gradient of the fluid on the region in the vicinity of the wall surface is increased. Then, the flat plate-like particles receive an asymmetric force due to the velocity gradient to move in the different direction from the flow direction as a rotational movement, for example. Because of this, the flow is further disturbed.

As a result of the formation of the thick boundary layer, there arises a problem that the wall surface resistance is increased and the discharge becomes unstable. The problem is described in detail as follows.

FIG. 8 is a waveform chart illustrating an example of a driving signal S11 to be supplied to the piezoelectric actuators according to a technique in the past. As illustrated in FIG. 8, if the driving signal S11 having such waveform is applied to the actuators, a discharge pressure acts on the metallic ink in the pressure generation chambers at a first rising portion and the metallic ink is discharged through the nozzles with no problem. The metallic ink is pressurized in the discharge direction to be discharged simply in the discharge operation with the driving signal S11. Therefore, the viscosity of the metallic ink and the increase in the wall surface resistance in the nozzles due to the metallic ink containing the pigment of the flat plate-like particle arise no special disadvantage. However, since the metallic ink is pressurized in the discharge direction simply as described above, a large discharge velocity cannot be obtained.

Then, a driving signal as illustrated in FIG. 9 has been proposed in order to obtain a sufficient discharge velocity. As illustrated in FIG. 9, a predetermined intermediate voltage Vm is applied with a driving signal S12. With the application of the voltage, the metallic ink is moved in the drawing direction opposite to the discharge direction of the metallic ink from the state where the piezoelectric actuators are deflected slightly so as to get momentum. Thereafter, in this state, the pressure is made to act on the metallic ink in the discharge direction. With this, the metallic ink that has got momentum in the drawing direction can be pressed drastically in the discharge direction, thereby obtaining a sufficient large discharge velocity.

However, when the piezoelectric actuators are driven with the driving signal S12 as illustrated in FIG. 9, there arises a problem that discharge becomes unstable when the metallic ink having the large wall surface resistance is discharged. More in detail, when the drawing operation has been performed before the main discharge in this case, the flow in the discharge direction is inhibited even if the metallic ink is tried to be discharged. That is, the flow in the discharge direction is inhibited due to the metallic ink present on the boundary layer portions in the vicinity of the inner wall surfaces of the nozzles, which has the large wall surface resistance and is restricted from being moved. As a result, the discharge becomes unstable. It is considered that this problem arises for the following reason. That is, the movement direction of the metallic ink with the drawing operation before the discharge operation and the movement direction with the discharge operation are inversed but the metallic ink on the boundary layers cannot follow the inverse of the movement directions in some cases.

It is to be noted that the above-mentioned problem occurs not only on the ink jet recording head but on the liquid ejecting heads for ejecting liquids other than ink as long as the liquids contain the flat plate-like particles as the pigment.

### SUMMARY

An advantage of some aspects of the invention is to provide a liquid ejecting head and a liquid ejecting apparatus that are capable of realizing liquid discharge stability even when liquid containing a pigment of flat plate-like particles is discharged and a drawing operation before main discharge is performed.

A liquid ejecting head according to an aspect of the invention includes a pressure generation chamber to which liquid containing a flat plate-like particle is filled, a pressure generation unit that generates pressure change on the liquid in the pressure generation chamber with supply of a driving signal, and a nozzle plate on which a nozzle for discharging the liquid in the pressure generation chamber with the pressure change is formed. In the liquid ejecting head, the nozzle includes at least a first nozzle portion that is formed at a side of a discharge surface of the liquid and a second nozzle portion that communicates with the first nozzle portion and is formed at a side of the pressure generation chamber, and the nozzle satisfies an expression of φ2/φ1≧1.4 when an opening diameter of the first nozzle portion at the side of the discharge surface is assumed to be φ1 and an opening diameter of the second nozzle portion at the side of the pressure generation chamber is assumed to be φ2.

According to the aspect of the invention, a boundary layer in the vicinity of the inner circumferential surface of the nozzle from the side of the pressure generation chamber to the side of the discharge end is made thinner so as to realize the smooth flow on the center portion. As a result, the metallic ink containing the flat plate-like particle as the pigment can be discharged preferably even when the metallic ink is drawn to the side of the pressure generation chamber once, and then, discharged.

In the aspect of the invention, it is preferable that a relation between the opening diameters φ1 and φ2 satisfy an expression of φ2/φ1≧1.6. Further, it is preferable that the flat plate-like particle satisfy an expression of b/a≧0.03 when the dimension of a diagonal line on a surface of the flat plate-like particle is assumed to be “a” and the thickness of the flat plate-like particle is assumed to be “b”.

A liquid ejecting apparatus according to another aspect of the invention includes the above-mentioned liquid ejecting head.

According to the aspect of the invention, liquid such as the metallic ink containing the flat plate-like particle can be discharged onto a medium preferably so as to contribute to the excellent printing of a printed matter or the like required to have constant glossiness preferably, for example.

### BRIEF DESCRIPTION OF THE DRAWINGS

The invention will be described with reference to the accompanying drawings, wherein like numbers reference like elements.

FIG. 1 is a schematic perspective view illustrating a configuration of a liquid ejecting apparatus.

FIG. 2 is an exploded perspective view illustrating a schematic configuration of a recording head according to an embodiment.

FIG. 3 is a plan view of FIG. 2.

FIG. 4 is a cross-sectional view cut along a line IV-IV in FIG. 3.

FIG. 5 is an enlarged view illustrating a nozzle and a portion in the vicinity of the nozzle in the embodiment.

FIG. 6 is a descriptive view for explaining a flat plate-like particle for evaluating a discharge characteristic conceptually.

FIG. 7 is a characteristic view illustrating a relation between a nozzle diameter and the number of discharge unstable nozzles.

FIG. 8 is a waveform chart illustrating an example of a waveform of a driving signal in a liquid ejecting apparatus in the past.

FIG. 9 is a waveform chart illustrating another example of the waveform of the driving signal in the liquid ejecting apparatus in the past.

### DESCRIPTION OF EXEMPLARY EMBODIMENTS

Hereinafter, an embodiment of the invention is described in detail with reference to the accompanying drawings.

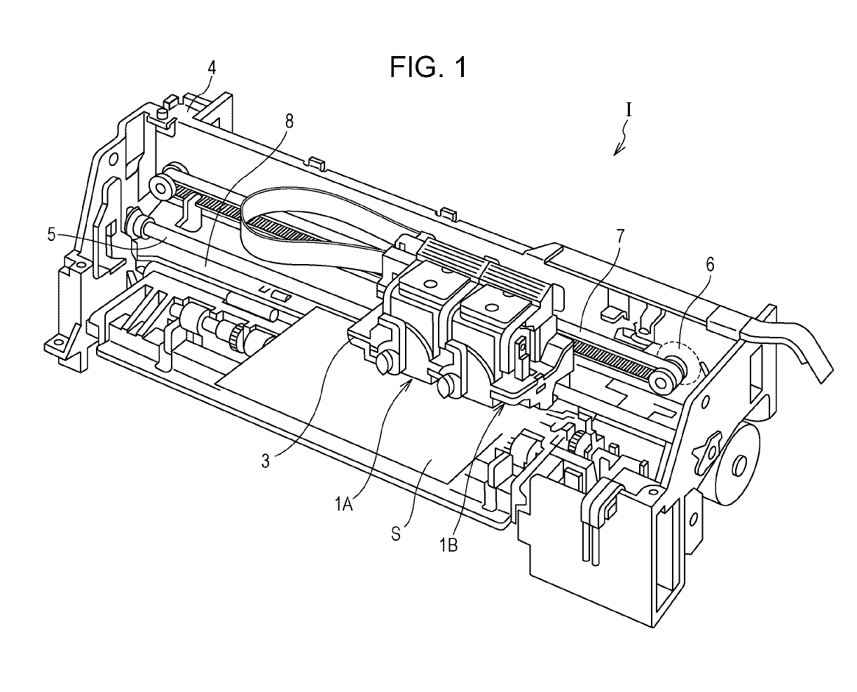

FIG. 1 is a schematic view illustrating an example of an ink jet recording apparatus (hereinafter, also referred to as recording apparatus). As illustrated in FIG. 1, recording head units 1A and 1B are provided on an ink jet recording apparatus I as a liquid discharge apparatus. That is to say, the recording head units 1A and 1B are mounted on a carriage 3 of the ink jet recording apparatus I. The carriage 3 is provided on a carriage shaft 5 attached to an apparatus main body 4 of the ink jet recording apparatus I so as to be movable in the axial direction. The recording head units 1A and 1B discharge black ink composition and color ink composition, respectively, for example. As the ink in the embodiment, metallic ink containing flat plate-like particles that are metal particles as a pigment so as to obtain glossiness is used. The flat plate-like particle indicates a particle having a flattened shape satisfying an expression of (R50/Z)>2 (hereinafter, the same is applied). In the expression, if a radius of a circle when the flat plate-like particle is replaced by a circle having the equivalent area to it is assumed to be “R”, a particle diameter when the presence rate of the particles having the radius “R” is 50% is assumed to be “R50”, and the thickness of the flat plate-like particle is assumed to be “Z”.

A driving force of a driving motor 6 is transmitted to the carriage 3 through a plurality of gears (not illustrated) and a timing belt 7. With this, the carriage 3 on which the recording head units 1A and 1B are mounted is moved along the carriage shaft 5. On the other hand, a platen 8 is provided on the apparatus main body 4 along the carriage shaft 5 and a recording sheet S as a recording medium, such as paper, which has been fed by a paper feeding roller (not illustrated in FIG. 1) and the like, is wound around the platen 8 so as to be transported.

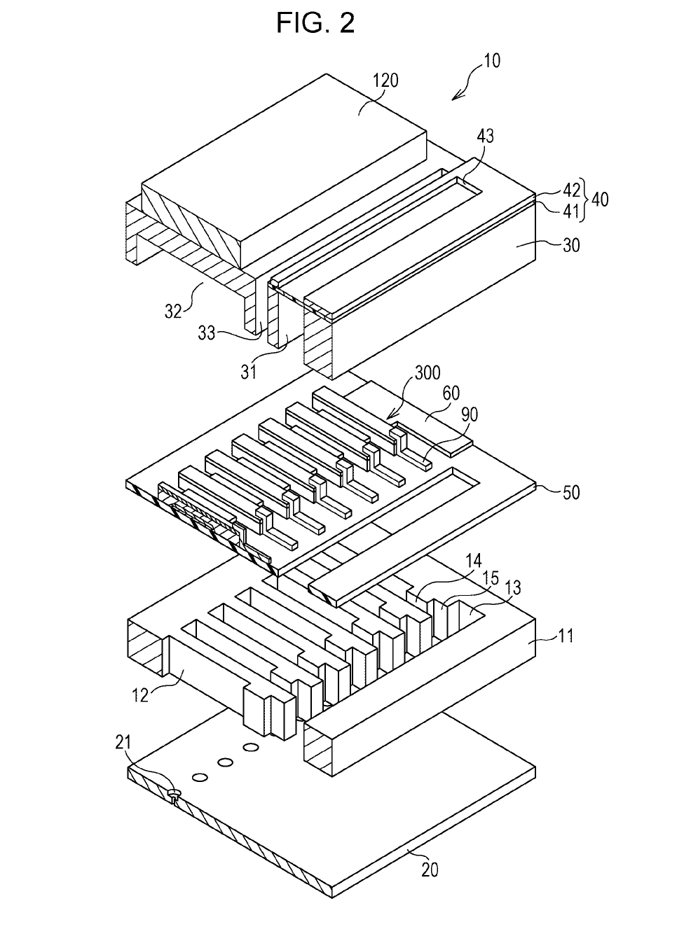

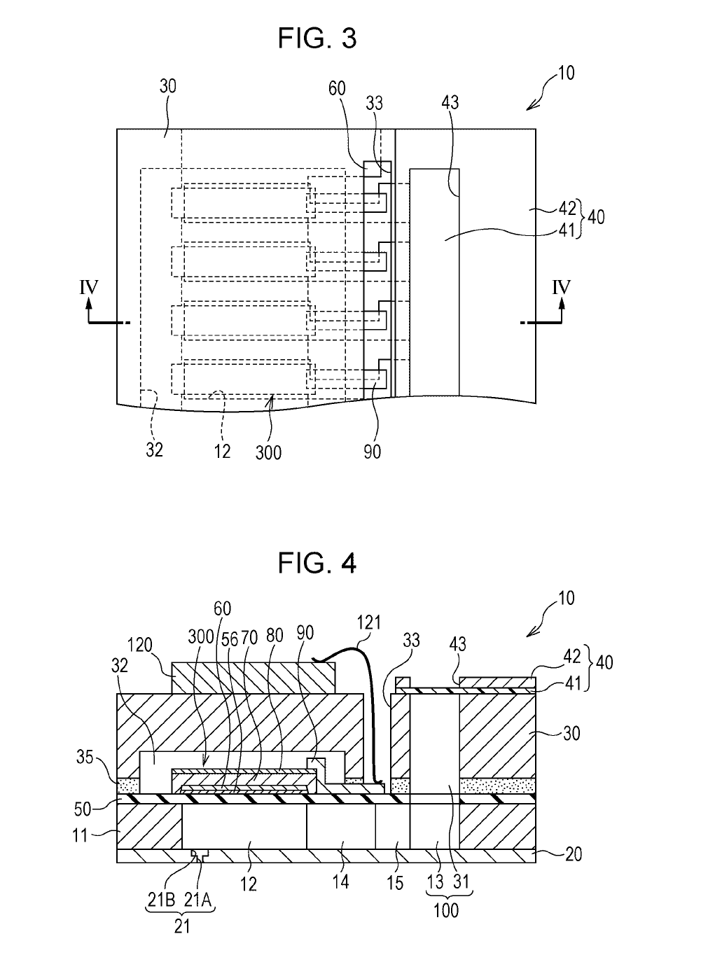

FIG. 2 is an exploded perspective view illustrating a schematic configuration of the ink jet recording head (hereinafter, also referred to as recording head) incorporating the recording head units 1A and 1B as illustrated in FIG. 1. FIG. 3 is a plan view of FIG. 2. FIG. 4 is a cross-sectional view cut along a line IV-IV in FIG. 3.

As illustrated in FIG. 2 to FIG. 4, a flow path formation substrate 11 of a recording head 10 is formed by a silicon single crystal substrate. An elastic film 50 is formed on one surface of the flow path formation substrate 11. The elastic film 50 is made of silicon dioxide and corresponds to a vibrating portion in the embodiment. A plurality of pressure generation chambers 12 are provided on the flow path formation substrate 11 so as to be in parallel in the width direction thereof. Further, a communicating portion 13 is formed on the flow path formation substrate 11 at the outer region of the pressure generation chambers 12 in the lengthwise direction thereof. The communicating portion 13 and the respective pressure generation chambers 12 communicate with each other through ink supply paths 14 and communication paths 15 provided for the respective pressure generation chambers 12. The communicating portion 13 communicates with a manifold portion 31 on a protection substrate 30, which will be described later, so as to constitute a part of a manifold 100 as an ink chamber common to the pressure generation chambers 12. The ink supply paths 14 are formed to have widths narrower than the pressure generation chambers 12 so as to keep flow path resistances of ink flowing into the pressure generation chambers 12 from the communicating portion 13 constant. In the embodiment, the ink supply paths 14 are formed by narrowing the widths of the flow paths from one side. However, the ink supply paths may be formed by narrowing the widths of the flow paths from both the sides. Alternatively, the ink supply paths may be formed not by narrowing the widths of the flow paths but by narrowing the flow paths from the thickness direction. In this manner, a liquid flow path constituted by the pressure generation chambers 12, the communicating portion 13, the ink supply paths 14, and the communication paths 15 is provided on the flow path formation substrate 11. Ink is filled into the pressure generation chambers 12 through the liquid flow path.

A nozzle plate 20 is made to adhere fixedly to one surface of the flow path formation substrate 11 at the opening surface side with an adhesive, a thermal welding film, or the like. Nozzles 21 communicating with the vicinity of the ends of the pressure generation chambers 12 at the side opposite to the ink supply paths 14 are bored on the nozzle plate 20. The nozzle plate 20 can be formed by a glass ceramic, a silicon single crystal substrate, a stainless steel, or the like preferably.

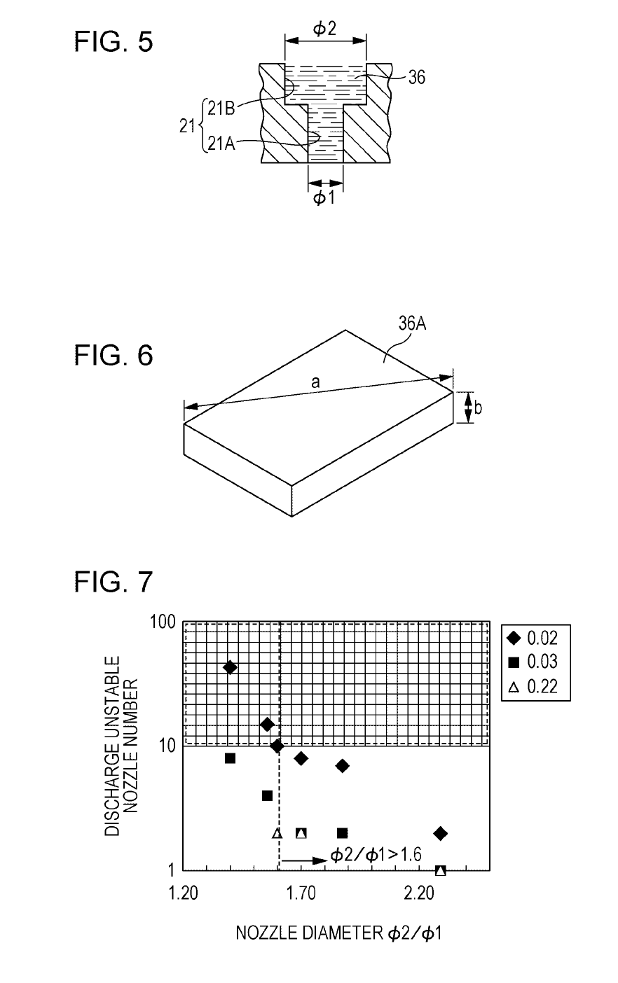

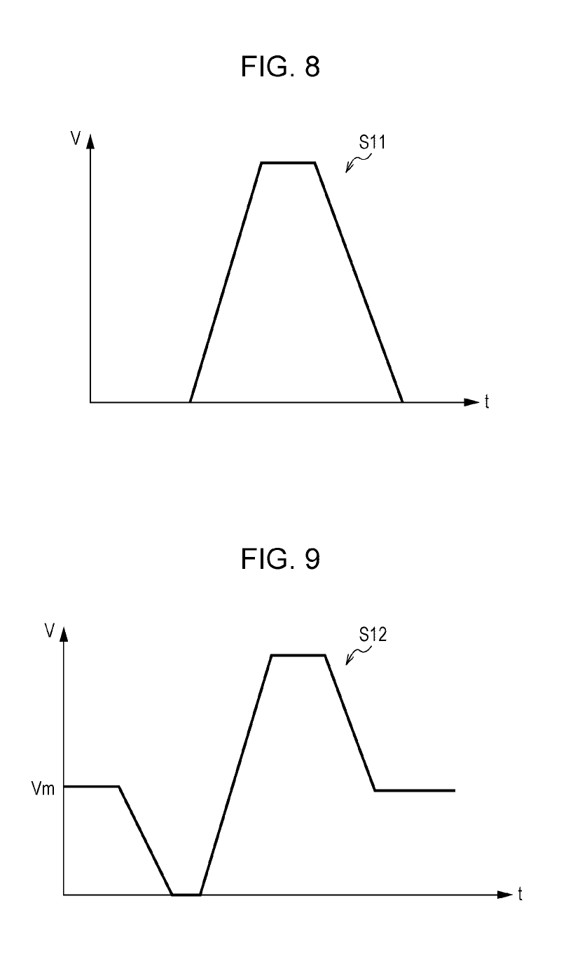

Each nozzle 21 in the embodiment is constituted as a two-stage nozzle having a first nozzle portion 21A and a second nozzle portion 21B as the nozzle portion and a portion in the vicinity thereof are illustrated in an enlarged manner as an example in FIG. 5. The first nozzle portion 21A is formed at the side of the ink discharge surface. The second nozzle portion 21B communicates with the first nozzle portion 21A and is formed at the side of the pressure generation chamber. Further, in the embodiment, the nozzle is configured such that an expression of φ2/φ1≧1.4 is satisfied when an opening diameter of the first nozzle portion 21A at the side of the discharge end is assumed to be φ1 and an opening diameter of the second nozzle portion 21B at the side of the pressure generation chamber is assumed to be φ2. A reference numeral 36 in FIG. 5 indicates metallic ink.

Returning to FIG. 2 to FIG. 4, the elastic film 50 is formed on the opening surface of the flow path formation substrate 11 at the opposite side as described above. An adhesion layer 56 is provided on the elastic film 50. The adhesion layer 56 is made of titanium oxide or the like having the thickness of approximately 30 to 50 nm, for example. The adhesion layer 56 is a layer for improving adhesiveness of the elastic film 50 and the like to a first electrode 60 substrate. An insulating film made of zirconium oxide may be provided on the elastic film 50 if necessary.

Further, the first electrode 60, a piezoelectric layer 70, a second electrode 80 are formed on the adhesion layer 56 in a lamination manner so as to constitute each piezoelectric element 300. The piezoelectric layer 70 is a thin film having the thickness of equal to or smaller than 2 μm, preferably 0.3 to 1.5 μm. The piezoelectric element 300 corresponds to a pressure generation unit in the embodiment. The piezoelectric element 300 indicates a portion including the first electrode 60, the piezoelectric layer 70, and the second electrode 80. In general, each piezoelectric element 300 is configured such that one of the electrodes included in the piezoelectric element 300 is set as a common electrode and the other thereof and the piezoelectric layer 70 are patterned for each pressure generation chamber 12. In the embodiment, the first electrode 60 is set as the common electrode to the piezoelectric elements 300 and the second electrodes 80 are set as individual electrodes of the piezoelectric elements 300. There arises no problem even if these electrodes are inversed for convenience of driving circuits and wirings. The piezoelectric elements 300 and a vibrating plate that is displaced by driving of the piezoelectric elements 300 are collectively referred to as an actuator device. In the above-mentioned example, the elastic film 50, the adhesion layer 56, the first electrode 60, and the insulating film provided if necessary act as the vibrating plate. It is needless to say that the vibrating plate is not limited thereto. For example, the elastic film 50 and the adhesion layer 56 may not be provided. Alternatively, the piezoelectric elements 300 themselves may also serve as the vibrating plate substantively.

Lead electrodes 90 are connected to the second electrodes 80 as the individual electrodes of the piezoelectric elements 300. The lead electrodes 90 are drawn from the vicinity of the end portions of the second electrodes 80 at the side of the ink supply paths 14 so as to extend onto the elastic film 50 or the insulating film provided if necessary. The lead electrodes 90 are made of gold (Au), for example.

The protection substrate 30 is bonded onto the flow path formation substrate 11 on which the piezoelectric elements 300 are formed with an adhesive 35. That is to say, the protection substrate 30 is bonded onto the first electrode 60, the elastic film 50, the insulating film provided if necessary, and the lead electrodes 90. The protection substrate 30 has the manifold portion 31 constituting at least a part of the manifold 100. In the embodiment, the manifold portion 31 penetrates through the protection substrate 30 in the thickness direction and is formed over the width direction of the pressure generation chambers 12. As described above, the manifold portion 31 communicates with the communicating portion 13 of the flow path formation substrate 11 so as to constitute the manifold 100 as the ink chamber common to the respective pressure generation chambers 12. Further, the communicating portion 13 of the flow path formation substrate 11 may be divided for the respective pressure generation chambers 12 and only the manifold portion 31 may be constituted as the manifold. Further, only the pressure generation chambers 12 may be provided on the flow path formation substrate 11, for example. In this case, the ink supply paths 14 communicating the manifold 100 and the respective pressure generation chambers 12 may be provided on a member (for example, the elastic film 50, the insulating film provided if necessary, or the like) interposed between the flow path formation substrate 11 and the protection substrate 30.

A piezoelectric element holding portion 32 is provided on the protection substrate 30 on a region opposed to the piezoelectric elements 300. The piezoelectric element holding portion 32 may have a space so as not only to inhibit the motion of the piezoelectric elements 300. It is sufficient that the piezoelectric element holding portion 32 may have a space so as not to inhibit the motion of the piezoelectric elements 300 and the space may be sealed or may not be sealed.

As a material of the protection substrate 30, a material having substantially the same coefficient of thermal expansion as that of the flow path formation substrate 11, for example, a glass, a ceramic material, or the like is used preferably. In the embodiment, the protection substrate 30 is formed by using the silicon single crystal substrate that is the same material as the flow path formation substrate 11.

Further, a through-hole 33 is provided on the protection substrate 30. The through-hole 33 penetrates through the protection substrate 30 in the thickness direction thereof. Portions in the vicinity of the ends of the lead electrodes 90 drawn from the respective piezoelectric elements 300 are exposed in the through-hole 33.

A driving circuit 120 that is controlled by a controller (not illustrated) and drives the piezoelectric elements 300 is fixed onto the protection substrate 30. For example, a circuit substrate, a semiconductor integrated circuit (IC), or the like can be used as the driving circuit 120. The driving circuit 120 and the lead electrodes 90 are electrically connected to each other through a connection wiring 121 formed by a conductive wire such as a bonding wire.

A compliance substrate 40 is bonded onto the protection substrate 30 having the above-mentioned configuration. The compliance substrate 40 is constituted by a sealing film 41 and a fixing plate 42. The sealing film 41 is made of a material having flexibility and low rigidity and one surface of the manifold portion 31 is sealed by the sealing film 41. Further, the fixing plate 42 is made of a relatively hard material. A region of the fixing plate 42, which is opposed to the manifold 100, corresponds to an opening 43 on which the fixing plate 42 is completely removed in the thickness direction. Therefore, one surface of the manifold 100 is sealed only by the sealing film 41 having flexibility.

In the recording head 10, ink is taken from an ink introduction port connected to an external ink supply unit (not illustrated) and inner portions from the manifold 100 to the nozzles 21 are filled with the ink. Thereafter, a voltage is applied to between the first electrode 60 and the respective second electrodes 80 corresponding to the respective pressure generation chambers 12 in accordance with a driving signal (for example, driving signal S12) from the driving circuit 120. The elastic film 50, the adhesion layer 56, the first electrode 60, and the piezoelectric layers 70 are deformed in a deflection manner with the voltage application. With this, vibration with the deformation is transmitted to the ink in the respective pressure generation chambers 12 through the elastic film 50 functioning as the vibrating portion. As a result, the pressures in the respective pressure generation chambers 12 are increased and ink droplets containing the flat plate-like particles as the pigment are discharged through the nozzles 21. The nozzles 21 in the embodiment are configured as the two-stage nozzles as described above such that the expression of φ2/φ1≧1.4 is satisfied. Therefore, the metallic ink containing the flat plate-like particles as the pigment can be discharged preferably even when the metallic ink is discharged with the driving signal S12 as illustrated in FIG. 9. As a reason of this, it is considered that the two-stage nozzles configured so as to satisfy the expression φ2/φ1≧1.4 make it possible to make the boundary layers formed along the inner circumferential surfaces of the nozzles 21 as thin as possible.

Table 1 indicates a result of examination about the number of discharge unstable nozzles when the metallic ink containing the plate-like particles having various shapes is discharged by the liquid ejecting head according to the embodiment for three types of pigment shape parameters (b/a).

A parameter of the nozzle shape is set to φ2/φ1. Further, the pigment shape parameter (b/a) indicates a ratio of the thickness dimension “b” relative to the diagonal line dimension “a” of the surface when a flat plate-like particle 36A is considered to have a rectangular parallelepiped shape as illustrated in FIG. 6. Accordingly, as the pigment shape parameter is smaller, the flat plate-like particle 36A is more flattened and tends to cause unstable discharge due to the disturbed flow with the discharge.

The evaluation conditions of the discharge characteristic in this case are as follows. That is, an ink droplet velocity is set to 6 m/s and a discharge frequency is set to 1 kHz. The evaluation of continuous discharge stability is made by discharging ink through all the nozzles 21 for 30 seconds continuously and examining whether or not abnormality (velocity lowering, deterioration in landing accuracy) occurs.

TABLE 1

| nozzle shape | pigment shape parameter (b/a) | | |
|---|---|---|---|
| Φ2/Φ1 | 0.02 | 0.03 | 0.22 |
| 1.40 | 43 | 8 | — |
| 1.56 | 15 | 4 | — |
| 1.60 | 10 | — | 2 |
| 1.70 | 8 | 2 | 2 |
| 1.88 | 7 | 2 | — |
| 2.29 | 2 | 1 | 1 |

By referring to Table 1, the following is found. That is, for each pigment shape parameter (b/a), as the nozzle shape (φ2/(φ1) is larger, that is, the opening diameter (φ2 of the nozzle portion 21B is larger relative to the opening diameter (φ1 of the nozzle portion 21A, the number of discharge unstable nozzles is reduced and the metallic ink can be discharged stably.

Based on the result of Table 1, evaluation of the discharge stability for the respective combinations is illustrated in Table 2. In Table 2, double circles indicate “very preferable”, circles indicate “preferable”, and crosses indicate “unavailable”. The evaluation is made by setting the range where stable printing can be expected on the discharge evaluation to “the number of discharge unstable nozzles≦10” as a reference in consideration of the number of discharge unstable nozzles and recording quality in the actual printing in the recording head 10 that discharges the metallic ink containing the flat plate-like particles having the respective shapes.

TABLE 2

| nozzle shape | pigment shape parameter (b/a) | | |
|---|---|---|---|
| Φ2/Φ1 | 0.02 | 0.03 | 0.22 |
| 1.40 | X | ◯ | ⊙ |
| 1.56 | X | ⊙ | ⊙ |
| 1.60 | ◯ | ⊙ | ⊙ |
| 1.70 | ◯ | ⊙ | ⊙ |
| 1.88 | ◯ | ⊙ | ⊙ |
| 2.29 | ⊙ | ⊙ | ⊙ |

The evaluation results of Table 1 and Table 2 are illustrated in FIG. 7. As illustrated in FIG. 7, even when the pigment shape parameter (b/a) is 0.02, if the nozzle shape (φ2/φ1) is larger than 1.6, the expression “the number of discharge unstable nozzles≦10” is satisfied. Therefore, in such a case, sufficient discharge stability is obtained. As the pigment shape parameter (b/a) is smaller, the flat plate-like particles contained in the metallic ink are more flattened. Therefore, it is more preferable in terms of glossiness. Accordingly, depending on the glossiness to be required, predetermined discharge stability is obtained in the range of the nozzle shape (φ2/φ1)≧1.4.

Therefore, according to the embodiment having a configuration in which the relation between the opening diameter of the first nozzle portion 21A and the opening diameter of the second nozzle portion 21B satisfies the expression φ2/φ1≧1.4, a sufficient stable discharge characteristic is obtained even when the metallic ink containing the flat plate-like particles is used. In this case, it is needless to say that the range of φ2/φ1≧1.6 is more preferable. It is to be noted that measurement values described in the specification also include errors at some degree.

### Other Embodiments

The embodiment of the invention has been described thus far. The basic configuration of the invention is not limited to the above-mentioned configuration. For example, the nozzles 21 in the above-mentioned embodiment are formed such that the inner circumferential surfaces of the second nozzle portions 21B are in parallel with the ink discharge direction and are continuous to the first nozzle portions 21A through stair-like step portions. However, the invention is not limited to the stair-like shapes. The inner circumferential surfaces of the second nozzle portions 21B may have tapered shapes inclined with respect to the discharge direction, or the like, as long as the relation between the opening diameters of the first nozzle portions 21A at the side of the discharge surface and the opening diameters of the second nozzle portions 21B at the side of the pressure generation chambers has a predetermined dimensional relation as in the above-mentioned embodiment.

Further, as illustrated in FIG. 4, the nozzles 21 in the above-mentioned embodiment are configured so as to communicate with the pressure generation chambers 12 directly. However, the configuration is not limited thereto and the nozzles 21 may communicate with the pressure generation chambers 12 through other liquid flow path constituent portions.

The nozzles 21 in the above-mentioned embodiment are formed on the nozzle plate 20. However, the nozzles 21 are not limited thereto and may be formed by a plurality of members.

Further, the recording apparatus I in the above-mentioned embodiment includes the piezoelectric actuators using thin film-type piezoelectric elements as the pressure generation unit that generates pressure change on the pressure generation chambers 12. However, the invention is not required to be limited thereto. For example, thick film-type piezoelectric actuators formed by a method of bonding a green sheet, or the like, piezoelectric actuators using longitudinal vibration-type piezoelectric elements in which piezoelectric materials and electrode formation materials are alternately laminated to be expanded and contracted in the axial direction, or the like, can be also used.

The embodiment as illustrated in FIG. 1 corresponds to a so-called serial-type ink jet recording apparatus in which the recording head units 1A and 1B are mounted on the carriage 3 moving in the direction (main scanning direction) intersecting with the transportation direction of the recording sheet S and printing is performed while moving the recording head units 1A and 1B in the main scanning direction. However, the invention is not limited thereto. It is needless to say that the invention can be applied to a so-called line-type ink jet recording apparatus in which a recording head is fixed and printing is performed only by transporting the recording sheet S.

Further, in the above-mentioned embodiment, the ink jet recording apparatus has been described as an example of a liquid ejection apparatus. However, the invention is widely applied to liquid ejection apparatuses including liquid ejecting heads that discharge liquids containing the flat plate-like particles. It is needless to say that the invention can be also applied to a liquid ejection apparatus including a liquid ejecting head that ejects liquid other than ink. As other liquid ejecting heads, various recording heads to be used for an image recording apparatus such as a printer, a color material ejecting head to be used for manufacturing color filters of a liquid crystal display and the like, an electrode material ejecting head to be used for forming electrodes of an organic EL display, a field emission display (FED), and the like, a bioorganic compound ejecting head to be used for manufacturing a bio chip, and the like can be exemplified.

The entire disclosure of Japanese Patent Application No. 2012-184258 filed Aug. 23, 2012 is expressly incorporated by reference herein.

What is claimed is:

1. A liquid ejecting head comprising:
a pressure generation chamber to which liquid containing a flat plate-like particle is filled;
a pressure generation unit that generates pressure change on the liquid in the pressure generation chamber with supply of a driving signal, and
a nozzle plate on which a nozzle for discharging the liquid in the pressure generation chamber with the pressure change is formed,
wherein the nozzle includes at least a first nozzle portion that is formed at a side of a discharge surface of the liquid and a second nozzle portion that communicates with the first nozzle portion and is formed at a side of the pressure generation chamber, and
the nozzle satisfies an expression of φ2/φ1≧1.4 when an opening diameter of the first nozzle portion at the side of the discharge surface is assumed to be φ1 and an opening diameter of the second nozzle portion at the side of the pressure generation chamber is assumed to be φ2.

2. The liquid ejecting head according to claim 1,
wherein a relation between the opening diameters φ1 and φ2 satisfies an expression of φ2/φ1≧1.6

3. The liquid ejecting head according to claim 1,
wherein the flat plate-like particle satisfies an expression of b/a≧0.03 when a dimension of a diagonal line on the surface of the flat plate-like particle is assumed to be a and the thickness of the flat plate-like particle is assumed to be b.

4. A liquid ejecting apparatus comprising the liquid ejecting head according to claim 1.

5. A liquid ejecting apparatus comprising the liquid ejecting head according to claim 2.

6. A liquid ejecting apparatus comprising the liquid ejecting head according to claim 3.
